(19) United States
(12) Patent Application Publication
(10) Pub. No.: US 2025/0102412 A1
(43) Pub. Date: Mar. 27, 2025

(54) Inline particle size analyzing device for continuous measurement of particle sizes of a continuously taken measurement sample of a bulk material, mill, method for controlling a mill for grinding bulk material to be ground in dependence on measurement results of an inline particle size analyzing device, computer program product and non-transitory computer-readable storage medium

(71) Applicant: TIETJEN VERFAHRENSTECHNIK GMBH, HEMDINGEN (DE)

(72) Inventor: MARKUS ECKERT, HEMDINGEN (DE)

(73) Assignee: TIETJEN VERFAHRENSTECHNIK GMBH, HEMDINGEN (DE)

(21) Appl. No.: 18/895,953

(22) Filed: Sep. 25, 2024

(30) Foreign Application Priority Data
Sep. 26, 2023 (DE) 102023126032.4

(51) Int. Cl. G01N 15/02; G01N 15/0205

(52) U.S. Cl. CPC G01N 15/0272; G01N 15/0211

(57) ABSTRACT

Inline particle size analyzing device for continuous measurement of particle sizes of a continuously taken measurement sample of a bulk material ground by a mill includes a main conduit having a main conduit inlet opening and a main conduit outlet opening, a bypass conduit, which has a bypass conduit inlet opening and a bypass conduit outlet opening that are fluidically connected for continuously transporting the continuously collected measurement sample of the bulk material via a bypass conduit channel from the bypass conduit inlet opening and the bypass conduit outlet opening which is designed to continuously take a measurement sample of the bulk material transported in the main conduit channel and to continuously supply it to the bypass conduit channel via the bypass conduit inlet opening, and a particle measuring device provided in the bypass conduit channel.

### CROSS-REFERENCE TO FOREIGN PRIORITY APPLICATION

The present application claims the benefit under 35 U.S.C. §§ 119 (b), 119(e), 120, and/or 365(c) of German Application No. DE 102023126032.4 filed Sep. 26, 2023.

### FIELD OF THE INVENTION

The invention relates to an inline particle size analyzing device for continuous measurement of particle sizes of a continuously taken measurement sample of a bulk material. The invention also relates to a mill, in particular a hammer mill, for grinding bulk material to be ground. Furthermore, the invention relates to a method for controlling a mill for grinding bulk material to be ground in dependence on measurement results of an inline particle size analyzing device. Finally, the invention relates to a computer program product and a non-transitory computer-readable storage medium.

### BACKGROUND OF THE INVENTION

In grinding, a distinction is usually made between dry grinding and wet grinding. Bulk goods, such as wood, straw and fibers, as well as the raw materials for the production of compound feed, pet food, fish feed, grain cleaning and food can be ground using dry grinding. The production of alcohol, ethanol and the unpacking or shredding of biowaste (for processing) and for the production of silage disintegration is usually carried out as wet grinding.

The step of grinding (bulk) goods is usually preceded by dosing and may be followed by pelletizing, extrusion, and drying. Depending on the product, it may also be necessary to coat and package the ground and processed goods.

It is known to take samples of particles of a bulk material from a mill for analysis purposes. Sampling is usually carried out manually and offline in/after the known mills. There is a risk here that the sample taken is not representative of the ground bulk material, as the mixing parameters of the sample taken are only valid for an isolated point in time. As a result, defects in the process can only be detected with a delay. Consequently, in the event of a defect, large quantities of an already ground bulk material can no longer be sold. This is not only undesirable from an economic point of view, but also from a sustainability point of view in particular.

In addition, taking samples outside of the manufacturing process is time-consuming and prone to errors due to human influence. This also contributes to the fact that defects in the process can only be detected with a delay, which leads to the disadvantages mentioned above.

It is therefore a task of the present invention to provide an inline particle size analyzing device for continuous measurement of particle sizes of a continuously taken measurement sample of a bulk material, a mill, a method for controlling a mill for grinding bulk material to be ground in dependence on measurement results of an inline particle size analyzing device, a computer program product and a non-transitory computer-readable storage medium, which reduce or eliminate one or more of said disadvantages and/or are improved over existing solutions. In particular, it is a task of the present invention to provide an inline particle size analysis device for continuous measurement of particle sizes of a continuously taken measurement sample of a bulk material, a mill, a method for controlling a mill for grinding bulk material to be ground in dependence on measurement results of an inline particle size analysis device, a computer program product and a non-transitory computer-readable storage medium, which enable faster and improved defect identification in the grinding process of (bulk) materials. In addition or alternatively, it is furthermore in particular a task of the present invention to provide an inline particle size analyzing device for continuous measurement of particle sizes of a continuously taken measurement sample of a bulk material, a mill, a method for controlling a mill for grinding bulk material to be ground in dependence on measurement results of an inline particle size analysis device, a computer program product and a non-transitory computer-readable storage medium, which enable a more cost-effective operation of bulk material processing plants, in particular of mills grinding bulk material.

### SUMMARY OF THE INVENTION

The present disclosure solves the problem in a first aspect by means of an inline particle size analyzing device for continuous measurement of particle sizes of a continuously taken measurement sample of a bulk material. In particular, the inline particle size analyzing device is provided for continuous measurement of particle sizes of a continuously taken measurement sample of a bulk material ground by a mill. Furthermore, in a preferred manner, the inline particle size analyzing device is provided for the continuous measurement of particle sizes of a continuously taken measurement sample of a free-flowing bulk material ground by a mill.

Free-flowing bulk material means in particular that the ground bulk material, after it has left the grinding chamber of the mill, for example after a cell wheel sluice, an elevator discharge, or similar, flows or falls continuously and gravimetrically from a falling stream past a sampling point of a measurement sampling unit. As a result, there is no significant segregation or compaction of the components of the measurement sample to be taken for measurement with a particle measuring device, i.e., the measurement sample contains the fine and coarse components that correspond to the proportions of the ground bulk material.

To solve the problem according to this aspect, the inline particle size analyzing device comprises: a main conduit, which has a main conduit inlet opening and a main conduit outlet opening, which are fluidly connected for transporting the bulk material via a main conduit channel from the main conduit inlet opening to the main conduit outlet opening, a bypass conduit, which has a bypass conduit inlet opening and a bypass conduit outlet opening that are fluidically connected for continuously transporting the continuously collected measurement sample of the bulk material via a bypass conduit channel from the bypass conduit inlet opening and the bypass conduit outlet opening, wherein the bypass conduit is fluidically connected to the main conduit channel via the bypass conduit inlet opening for conveying the measurement sample taken from the bulk material to the bypass conduit, a measurement sampling unit, which is designed to continuously take a measurement sample of the bulk material transported in the main conduit channel and to continuously supply it to the bypass conduit channel via the bypass conduit inlet opening, a particle measuring device provided in the bypass conduit channel, which is designed for the continuous measurement of particle sizes of the taken measurement sample, with a measurement sample inlet, through which the measurement sample can be continuously fed to the particle measuring device, and with a measurement sample outlet arranged downstream of the particle measuring device and fluidically connected to the particle measuring device, through which the measurement sample detected by the particle measuring device in the bypass conduit channel can leave the particle measuring device in the direction of the bypass conduit outlet opening, wherein the measurement sampling unit has an adjustable measurement sampling inlet, the inlet opening size of which is adjustable between a first inlet opening size and a second inlet opening size different from the first inlet opening size, the second inlet opening size being larger than the first inlet opening size.

The sampling inlet has the particular advantage that the measurement sample quantity can be adjusted. In particular, by adjusting the inlet opening size of the sampling inlet, it is possible to set which measurement sample quantity is fed to the bypass pipe and thus to the particle measuring device for measuring and analyzing the ground bulk material. By adjusting the inlet opening size of the sampling inlet, the filling level of the measurement sampling unit, in particular the screw conveyor, with the measurement sample can be adjusted. For example, the filling level of the measurement sampling unit is 0% when the sampling inlet is completely closed. The filling level of the measurement sampling unit can be 100% when the sampling inlet is fully open. A preferred filling level of the measurement sampling unit is 30%, for example.

The described inline particle size analysis device enables automated measurement and analysis of the measurement sample of the ground bulk material. The particular advantage here is that the particle measuring device and thus the measurement is firmly integrated into the existing process and provides continuous, reproducible measurement results. By using defined limit values, the process parameters of the mill, for example the speed of a rotor and thus the speed of the hammer mill beaters connected to the rotor or the aspiration performance of the mill, can be adjusted directly. Wear conditions of the grinding tools or damage to the sieve structures can also be detected directly. The design of the inline particle size analyzing device according to the invention thus enables consistent quality and quantity of the ground bulk material.

In particular, automated and continuous sampling in the process (“inline”) ensures the quality of the ground bulk material independently of the machine operator, even if external factors influencing the bulk material to be ground change.

In particular, the solution according to the invention makes it possible to identify possible wear on the mill, for example the hammer mill beaters, sieves, and leaks, at an early stage. As a result, maintenance intervals can be adapted to the condition of the mill or maintenance measures can be taken in good time. As a result, maintenance work can not only be predicted better or at all, but the maintenance of the mill can also be carried out depending on its condition.

Examples of bulk goods include raw materials for the production of pet food of domestic animal feed, cattle feed, chicken feed, or pig feed. Raw materials include various types of grain.

The terms “continuously taken and continuously fed” mean that during operation of the inline particle size analysis device, a measurement sample is continuously, in particular without interruption, taken from the bulk material flowing through the main conduit during operation and this is continuously, in particular without interruption, fed to the bypass conduit and thus to the particle measuring device. The terms “continuously taken and continuously fed” do not mean, in particular, a discrete removal of the measurement sample from the bulk material flowing in the main conduit and, in particular, no discrete feeding of the taken measurement sample to the bypass conduit. In particular, the terms “continuously removed and continuously fed” do not mean removal and feeding of the measurement sample with interruption. In particular, for example, manually taking a measurement sample of the ground bulk material once an hour or less and its analysis in a measurement laboratory at a corresponding frequency of once an hour or less does not mean continuously taken and continuous analysis of the measurement sample. Preferably, periodic sampling and measurement of a measurement sample at 15 second intervals is also not to be understood as sampling and analysis of the measurement sample.

In relation to the particle measuring device, the phrase “continuously measured” means that the particle measuring device continuously, in particular without interruption, detects or measures the particle size of the measurement sample during operation. Preferably, the analysis of the measurement results is carried out continuously during operation, in particular without interruption.

This main conduit is designed to transport large quantities of bulk material. The quantities that can usually be transported with the main conduit are in the range of several tons. Depending on the bulk material, transport volumes of up to 80 tons per hour are conceivable, for which the main conduit should be designed. Accordingly, the main conduit can have a diameter of at least 50 cm, 100 cm, 150 cm, or 200 cm. The diameter of the main conduit is usually smaller than 500 cm, 400 cm, 300 cm, 200 cm, 150 cm, or 100 cm.

The main conduit is preferably designed as a pipe, for example made of steel or plastic. Embodiments in which the main conduit is designed as a hose may also be preferred.

The main conduit is usually designed to transport a much larger quantity of bulk material in comparison to the bypass conduit. Preferably, the main conduit has a diameter of DN300. The bypass conduit is designed to transport bulk material in the order of 1 dm³ per minute. This applies in particular to a filling level of the measurement sampling unit of 30%. For this purpose, the bypass conduit usually has a diameter of DN120 or DN200. Depending on the quantity of the ground bulk material and the desired quantity of the measurement sample, diameters other than this are also conceivable. Like the main conduit, the bypass conduit can be designed as a pipe or as a hose. Preferably, the bypass conduit is made of steel and/or plastic. The bypass conduit is preferably designed as a type of downpipe, so that the measurement sample is conveyed through the bypass conduit, in particular due to the gravity acting on the taken measurement sample.

The bypass conduit can be understood as a bypass conduit of the main conduit. Bulk material is continuously taken from the main conduit as a measurement sample using the measurement sampling unit and fed to the bypass conduit via the bypass conduit inlet opening. The supply of the taken measurement sample to the bypass conduit is also preferably carried out via the measurement sampling unit. For this purpose, the measurement sampling unit can, for example, be designed as a chute or comprise a chute via which the bulk material to be taken from the main conduit can be continuously fed to the bypass conduit due to gravity.

The measurement sampling unit is preferably used to continuously take 1 dm³ per minute from the main conduit and continuously feed it to the bypass conduit. This applies in particular to a filling of 30% of the measurement sampling unit.

The particle measuring device is preferably integrated into the bypass conduit between the bypass conduit inlet opening and the bypass conduit outlet opening. In particular, the particle measuring device is arranged in such a way that it forms part of the bypass conduit between the bypass conduit inlet opening and the bypass conduit outlet opening. The particle measuring device is designed for continuous measurement of the sample taken by the measurement sampling unit. In particular, the particle measuring device is designed to continuously measure a measurement sample in the order of magnitude of 1 dm³ per minute. It is particularly preferred that the particle measuring device is designed to continuously analyze a measurement sample in the order of magnitude of 1 dm³ per minute. This applies in particular to a filling of 30% of the measurement sampling unit. Preferably, the measurement results and the analysis results are stored on a memory unit. This storage unit can be included in the particle measuring device. However, it may also be preferable for the storage unit to be part of a computer system, for example a server or a computer.

Reference is also made to the following description of the corresponding features of the mill, the method, the computer program product, and the non-transitory computer-readable storage medium for the advantages, embodiments, and embodiment details of this aspect of the invention and its embodiments.

According to a preferred embodiment of the inline particle size analyzing device, the particle measuring device comprises: a measuring chamber formed within a measuring chamber housing, which is darkened with respect to the surroundings of the inline particle size analyzing device, a radiation detector which is designed to detect electromagnetic radiation and in particular a camera, particularly preferably an infrared camera, which comprises the radiation detector, and a radiation source for electromagnetic radiation, wherein the radiation source is in particular an infrared source and/or is designed as an LED, wherein the radiation detector and the radiation source are arranged in relation to the measuring chamber for continuous measurement of the measurement sample, wherein the radiation detector and the radiation source are preferably arranged opposite each other

Furthermore, according to a preferred embodiment, it is provided that the radiation detector is or comprises an optical matrix sensor with an evaluation unit; and/or the radiation source is a light source which is designed to emit a uniform light.

According to a further preferred embodiment of the inline particle size analysis device, it is provided that the camera comprises the radiation detector and the camera captures at least 24 images per second, preferably at least 360 images per second, particularly preferably at least 6,000 images per second, and/or records a maximum of up to 6,000 images per second, preferably a maximum of up to 10,000 images per second, more preferably a maximum of up to 20,000 or 25,000 images per second. Preferably, the camera captures 6,000 images per second.

The images are preferably evaluated using analysis software running on an analysis device. Preferably, the particle measuring device provides the measured values to the analysis software every second.

Furthermore, according to a preferred embodiment of the inline particle size analysis device, it is provided that the particle measuring device is configured for measuring particle sizes of at least 50 μm, preferably of at least 85 μm, particularly preferably of at least 160 μm. Additionally or alternatively, in this preferred embodiment of the inline particle size analysis device, it is provided that the particle measuring device is configured for measuring particle sizes of a maximum of 20,000 μm, preferably of a maximum of 10,000 μm, particularly preferably of a maximum of 6,000 μm.

Furthermore, in a preferred embodiment of the inline particle size analysis device, the radiation detector comprises detector pixels arranged in a matrix-like manner. In this preferred embodiment, the detector pixels have edge lengths of at least 50 μm*50 μm, preferably of at least 85 μm*85 μm, particularly preferably of at least 160 μm*160 μm. Additionally or alternatively, in this preferred embodiment, the detector pixels have edge lengths of a maximum of 20,000 μm*20,000 μm, preferably of a maximum of 10,000 μm*10,000 μm, particularly preferably of a maximum of 6,000 μm*6,000 μm.

In a further preferred embodiment of the inline particle size analyzing device, the measurement sampling unit comprises a conveying device extending from the main conduit channel and to the bypass conduit channel for continuously conveying the measurement sample to the bypass conduit channel.

According to a further preferred embodiment of the inline particle size analyzing device, it is provided that the conveying device has a conveying channel which extends between the inlet opening of the measurement sampling unit and a discharge opening, wherein the conveying device has a screw conveyor arranged in the conveyor channel so as to be rotatably driven by a conveyor drive unit, the screw conveyor preferably made of plastic or comprises plastic, and/or the conveyor channel is preferably made of steel; and/or an adjustable screw conveyor bottom for receiving the measurement sample and supplying the measurement sample to the measurement sampling unit, which is adjustable between a first screw conveyor bottom position and a second screw conveyor bottom position different from the first screw conveyor bottom position, so that the sampling inlet corresponds to the first inlet opening size when the screw conveyor bottom is arranged in the first screw conveyor bottom position and corresponds to the second inlet opening size when the screw conveyor bottom is arranged in the second screw conveyor bottom position; and/or the discharge opening is designed as a slot, wherein the slot-shaped discharge opening is designed in particular to distribute the measurement sample evenly over an opening cross-section of the bypass conduit channel.

The inlet opening size of the sampling inlet can be adjusted in particular by adjusting the screw conveyor bottom of the conveyor device accordingly. Preferably, the conveyor screw bottom of the conveyor device is continuously adjustable between the first conveyor screw bottom position and the second conveyor screw bottom position. In particular, it is preferred that the adjustment of the conveyor screw bottom of the conveyor device between the first conveyor screw bottom position and the second conveyor screw bottom position is carried out automatically, in particular by means of an adjustment unit, for example a motor. Preferably, the adjustment of the conveyor screw bottom position of the conveyor screw bottom between the first conveyor screw bottom position and the second conveyor screw bottom position takes place in dependence on a control signal, which can be provided by a control device. It may also be preferable to manually adjust the screw conveyor bottom between the first screw conveyor bottom position and the second screw conveyor bottom position.

In a preferred manner, the screw conveyor bottom forms part of the screw conveyor channel. In particular, the screw conveyor bottom forms the screw conveyor channel at its inlet opening. Preferably, the screw conveyor bottom can be moved in the axial direction along the screw conveyor or in or against the conveying direction of the screw conveyor. In particular, the screw conveyor bottom is arranged in such a way that the ground bulk material falls from the mill onto the screw conveyor bottom during operation or the screw conveyor bottom catches the (freely) falling ground bulk material. Preferably, the screw conveyor bottom is designed as a partial pipe segment for this purpose. It is preferably provided that the quantity of ground bulk material that collects in the screw conveyor bottom as a measurement sample is greater the more the screw conveyor bottom is deployed. In particular, it should be understood that essentially no ground bulk material is collected in the screw conveyor bottom when the screw conveyor bottom is fully retracted. In this last case, one preferably also speaks of a closed inlet opening, i.e., the sampling inlet is completely closed.

Furthermore, in a preferred embodiment, the inline particle size analysis device comprises a sample preparation path extending between the bypass conduit inlet opening and the measurement sample inlet of the particle measuring device, wherein the sample preparation path comprises a measurement sample preparation unit and/or an air purification unit.

According to a further preferred embodiment of the inline particle size analysis device, the measurement sample preparation unit comprises a measurement sample distributor plate which distributes the measurement sample supplied via the bypass conduit inlet opening in the sample preparation path, the measurement sample distributor plate preferably being arranged exchangeably and/or detachably on the bypass conduit. Additionally or alternatively, it is provided that the measurement sample preparation unit has a measurement sample distributor grid which distributes the measurement sample supplied via the bypass conduit inlet opening in the sample preparation path, wherein the measurement sample distributor grid preferably has a plurality of, in particular more than two, distributor rods arranged equidistantly from one another, wherein the distributor rods are preferably configured as round steel; and/or preferably the distribution rods have a diameter of at least 5 mm, in particular of at least 6 mm, particularly preferably of at least 10 mm; and/or preferably the distribution rods have a length of at least 100 mm, particularly preferably of at least 120 mm, and a maximum of 250 mm, particularly preferably of a maximum of 205 mm; and/or preferably the distribution rods are connected in a material-locking manner, in particular welded, to or with a wall of the bypass conduit. In addition or alternatively, it is provided that the sample preparation unit comprises a nozzle unit, wherein the nozzle unit is preferably arranged on the bypass conduit upstream of the measurement sample distributor grid and/or the measurement sample distributor plate.

Preferably, the diameter of the distributor rods is 6 mm and/or the distance between adjacent distributor rods is preferably 6 mm. By means of the nozzle unit, for example, the measurement sample distributor grid and/or the measurement sample distributor plate and/or the particle measuring device can be cleaned. For this purpose, the nozzle unit can be controlled with a corresponding cleaning control signal.

Preferably, the measurement sample distributor plate is designed as a slot. In particular, it is intended that the measurement sample distributor plate is arranged below the screw conveyor in the conveying direction of the measurement sample. Preferably, the measurement sample distributor plate forms the discharge opening of the conveyor channel. In particular, it is provided that the measurement sample distributor grid is arranged between the measurement sample distributor plate and the particle measuring device.

This preferred arrangement enables a particularly uniform distribution of the measurement sample in preparation for measurement with the particle measuring device. In particular, the measurement sample distributor grid ensures that the particle measuring device receives a representative image of the ground bulk material with the measurement sample.

Furthermore, in a preferred embodiment of the inline particle size analysis device, the particle measuring device comprises a measuring chamber inlet through which the measurement sample can be continuously supplied to the measuring chamber, and a measuring chamber outlet through which the measurement sample can continuously leave the measuring chamber.

In a further preferred embodiment of the inline particle size analysis device, the particle measuring device is adapted to perform a measurement of the supplied measurement sample when the amount of the measurement sample exceeds a limit amount. For this purpose, the amount of particles of the measurement sample fed through the particle measuring device is counted in dependence on a particle size class. It is preferably provided that the user of the mill can set a lower limit and/or an upper limit for the or a limit amount can be set at the factory.

Furthermore, according to a preferred embodiment, the inline particle size analyzing device comprises a dirt detection unit for detecting dirt in the particle measuring device, in particular at the radiation detector and/or the radiation source, wherein particularly preferably the radiation detector forms or is the dirt detection unit.

This is done in particular by measuring or detecting the shading of the measurement matrix, whereby a certain shading limit value (to be defined) must not be exceeded. If the limit value is exceeded, i.e., if there is contamination that does not allow reliable measurement of the measurement sample taken, for example, an alarm signal can be emitted or, if desired, grinding of the bulk material can be interrupted until the particle size analysis device has been cleaned.

Furthermore, in a preferred embodiment, the inline particle size analyzing device comprises a cleaning device for cleaning the particle measuring device, in particular the radiation detector and/or the radiation source, from contamination.

Finally, in a preferred embodiment of the inline particle size analyzing device, the cleaning device comprises or is a blower, in particular an air blower, for cleaning the particle measuring device, in particular the radiation detector and/or the radiation source.

In a second aspect of the invention, the task mentioned at the beginning is solved by a mill for grinding bulk material to be ground. The mill is in particular a hammer mill.

The mill according to this aspect comprises: a grinding chamber enclosed by a grinding chamber housing with a grinding device for grinding bulk to be ground, which grinding device is arranged within the grinding chamber so as to be rotatably drivable by a grinding drive unit, a bulk material inlet for feeding bulk material to be ground into the grinding chamber and a bulk material outlet for discharging bulk material ground by the grinding device from the grinding chamber, and an inline particle size analyzing device located downstream of the bulk material outlet, as previously described according to the first aspect and/or possible preferred embodiments thereof, for continuously measuring particle sizes of a continuously collected measurement sample of the bulk material ground by the grinding device, wherein the main conduit is fluidically coupled to the bulk material outlet via the main conduit inlet opening.

For the advantages, embodiments, and embodiment details of this aspect of the invention and its embodiments, reference is also made to the preceding description of the corresponding features of the inline particle size analyzing device and the following description of the corresponding features of the method, the computer program product and the non-transitory computer readable storage medium.

In a preferred embodiment, the mill has a sieving unit arranged at the bulk material outlet for sieving the ground bulk material.

Furthermore, according to a preferred embodiment of the mill, it is provided that an outlet unit with an outlet channel extends from the bulk material outlet, wherein the outlet unit preferably being designed as an outlet pipe or outlet conduit, and the inline particle size analyzing device forming a bypass conduit channel parallel to the outlet channel, wherein the outlet unit has an outlet opening and an inlet opening downstream of the outlet opening and the inline particle size analyzing device is fluidically connected to the outlet unit on the inlet side via the measurement sample inlet device and the outlet opening and on the outlet side via the measurement sample outlet device and the inlet opening.

Furthermore, according to a preferred embodiment, the mill comprises a control device which is signally connected to the particle measuring device and the grinding drive unit, wherein the control device being designed to control the grinding drive unit in dependence on measurement results of the continuous measurement by the particle measuring device and/or to control the level of an air volume flow which flows through the mill and/or the feed quantity of the bulk material to be ground.

In a third aspect of the invention, the task mentioned at the beginning is solved by a method for controlling a mill, in particular a hammer mill, for grinding bulk material to be ground in dependence on measurement results of an inline particle size analyzing device, in particular according to the first aspect described above or according to a possible preferred embodiment of this first aspect. The method comprises following steps:
Detection of an ACTUAL grain spectrum of a measurement sample by means of a particle measuring device,
Analysis of the detected ACTUAL grain spectrum,
Define a TARGET grain spectrum,
Comparison of the detected ACTUAL grain spectrum with the defined TARGET grain spectrum, and
Setting of one or more of the following mill parameters in dependence on the result of the comparison of the detected ACTUAL grain spectrum with the defined TARGET grain spectrum:
   Speed of a rotor of the mill, which drives several hammer mill beaters of the mill;
   Amount of an air volume flow that flows through the mill, and
   Feed quantity of the bulk material to be ground.

With regard to the advantages, embodiments and embodiment details of this aspect of the invention and its embodiments, reference is also made to the preceding description of the corresponding features of the inline particle size analyzing device and the mill and the following description of the corresponding features of the computer program product and the non-transitory computer-readable storage medium.

According to a fourth aspect of the invention, the above-mentioned task is solved by a computer program product that comprises program code to carry out, when executed by the processor circuit, the method described above according to the third aspect.

For the advantages, embodiments, and embodiment details of this aspect of the invention and its embodiments, reference is also made to the preceding description of the corresponding features of the inline particle size analyzing device, the mill and the method and the following description of the corresponding features of the non-transitory computer-readable storage medium.

According to a fifth aspect of the invention, the above-mentioned task is solved by a non-transitory computer-readable storage medium comprising instructions which, when executed by a processor circuit, cause the processor circuit to perform the previously described method according to the third aspect.

For the advantages, embodiments, and embodiment details of this aspect of the invention and its embodiments, reference is also made to the preceding description of the corresponding features of the inline particle size analyzing device, the mill, the method and the computer program product.

Embodiments of the invention are now described below with reference to the drawings. These are not necessarily intended to show the embodiments to scale; rather, where this is useful for explanation, the drawings are shown in schematized and/or slightly distorted form. Reference is made to the relevant state of the art with regard to additions to the teachings directly recognizable from the drawings. It should be noted that various modifications and changes can be made to the shape and detail of an embodiment without departing from the general idea of the invention. The features of the invention disclosed in the description, in the drawings and in the claims can be essential for the further development of the invention both individually and in any combination. In addition, all combinations of at least two of the features disclosed in the description, the drawings and/or the claims fall within the scope of the invention. The general idea of the invention is not limited to the exact form or detail of the preferred embodiments shown and described below, or limited to any subject matter that would be limited as compared to the subject matter claimed in the claims. In the case of stated dimensioning ranges, values lying within the stated limits are also to be disclosed as limit values and can be used and claimed as desired. For the sake of simplicity, the same reference signs are used below for identical or similar parts or parts with identical or similar functions.

### BRIEF DESCRIPTION OF THE DRAWINGS

Further advantages, features and details of the invention will become apparent from the following description of the preferred embodiments and from the drawings; these are shown in:

FIG. 1 is a schematic side view in sectional view of a mill according to a preferred embodiment;

FIG. 2 is a schematic side view in sectional view of an inline particle size analyzing device according to a preferred embodiment of the mill shown in FIG. 1;

FIG. 3 is a schematic three-dimensional sectional view of a section of the embodiment shown in FIG. 2;

FIG. 4 is a schematic representation of a preferred embodiment of a particle measuring device of the inline particle size analyzing device shown in FIGS. 2 and 3; and

FIG. 5 is a schematic block diagram of a preferred embodiment of a method for controlling a mill.

### DETAILED DESCRIPTION OF THE EMBODIMENTS

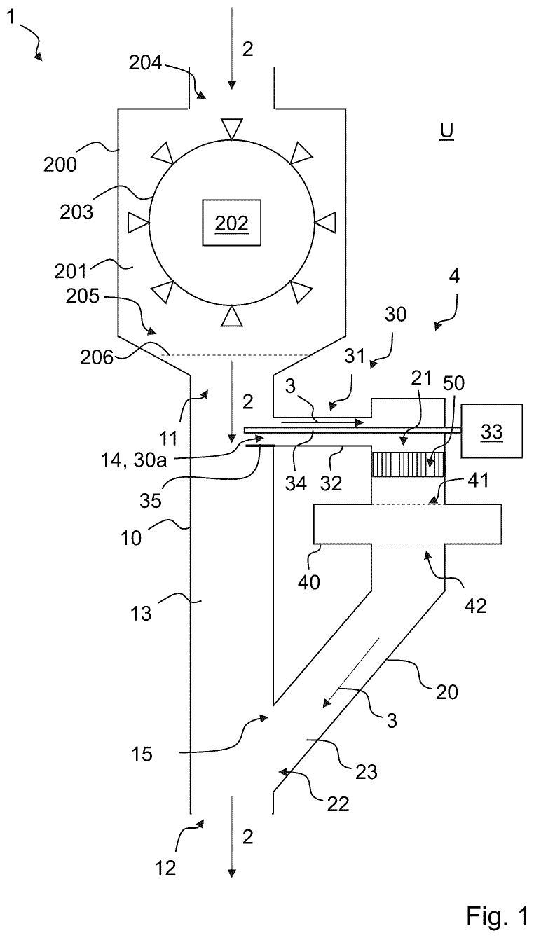

FIG. 1 shows a schematic side view in sectional view of a mill 1 according to a preferred embodiment. In this preferred embodiment, the mill 1 is designed as a hammer mill and is intended for grinding bulk material 2.

The mill 1 has a grinding chamber housing 200, which encloses a grinding chamber 201. The bulk material 2 to be ground is fed into the grinding chamber 201 via a bulk material inlet 204 and the ground bulk material 2 is discharged from the grinding chamber via a bulk material outlet 205. Accordingly, the grinding chamber housing 200 has the bulk material inlet 204 and the bulk material outlet 205. The bulk material inlet 204 is connected, for example, to a reservoir (not shown) in which the bulk material to be ground and already dosed is (temporarily) stored. A main conduit 10 in the form of a pipe is arranged at the bulk material outlet 205 via a main conduit inlet opening 11, which extends from the bulk material outlet 205 between the main conduit inlet opening 11 and the main conduit outlet opening 12 with a main conduit channel 13. The ground bulk material 2 can be transported away via the main conduit 10, for example to a storage tank for storing the ground bulk material. The ground bulk material can also be transported away to a pellet press, for example, or to an extruder or for drying.

In the present embodiment, it is provided that during operation of the mill, the bulk material inlet 204 is provided at approximately a 12 o'clock position and the bulk material outlet 205 is provided at approximately a 6 o'clock position. This has the advantage that the bulk material to be ground passes through the grinding chamber housing in the direction of action of gravity.

A grinding device 203 is provided within the grinding chamber 201 for grinding the bulk material 2. The grinding device 203 is arranged within the grinding chamber 201 so as to be rotatable about an axis of rotation with a grinding drive unit 202. For grinding the bulk material, the grinding device has several beaters which grind the bulk material 2 in a rotating manner in interaction with the grinding chamber housing 200. A sieving unit 206, which is arranged at the bulk material outlet 205, sieves the ground bulk material and thereby prevents clumping of the ground bulk material or dissolves possible clumping of the ground bulk material.

In the present embodiment of the mill 1, an inline particle size analyzing device 4 is provided for the continuous measurement of particle sizes of a continuously taken measurement sample 3 of the bulk material 2 ground by the grinding device 203. For this purpose, the inline particle size analyzing device 4 is fluidically connected to the grinding chamber housing 200 via the main conduit 10 and has a bypass conduit 20 in addition to the main conduit 10. The bypass conduit 20 is fluidically connected to the main conduit 10. For this purpose, the main conduit 10 has a bypass conduit outlet opening 14 and the bypass conduit 20 has a bypass conduit inlet opening 21, which are fluidically connected to each other.

For continuous removal of the measurement sample, the inline particle size analyzing device 4 has a measurement sampling unit 30. The measurement sampling unit 30 is arranged and designed to continuously remove the measurement sample 3 from the bulk material 2 transported in the main conduit channel 13 and to continuously provide it to the bypass conduit channel 23 via the bypass conduit inlet opening 21. For the continuous removal of the measurement sample and for the continuous transportation of the measurement sample from the main conduit channel 13 into the bypass conduit channel 23, the measurement sample removal unit 30 has a conveyor device 31 which comprises a conveyor screw 34 arranged in a conveyor channel 32 so as to be rotatably driven by a conveyor drive unit 33. The screw conveyor 34 is mechanically coupled to a conveyor drive unit 33, which drives the screw conveyor 34 for continuous removal and continuous transportation of the measurement sample from the main conduit channel 13 via the bypass conduit inlet opening 21 into the bypass conduit channel 23. Due to the rotation of the screw conveyor 34, the continuously collected measurement sample 3 is continuously removed from the main conduit 10 and continuously fed to the bypass conduit 20.

It is provided in the present case that the measurement sampling unit 30 has an adjustable measurement sampling inlet 30a, the inlet opening size of which is adjustable between a first inlet opening size and a second inlet opening size different from the first inlet opening size, wherein the second inlet opening size is larger than the first inlet opening size. Here, it is provided that the measurement sampling inlet 30a corresponds to the bypass conduit outlet opening 14. In the present embodiment example, the inlet opening size is selected between the first and second inlet opening sizes such that the degree of filling of the conveyor channel by the screw conveyor is 30%.

In the preferred embodiment shown, this is achieved by the conveyor device 31 having an adjustable screw conveyor bottom 35 which is displaceable along the screw conveyor, i.e., in and against the conveying direction of the screw conveyor of a first screw conveyor bottom position and a second screw conveyor bottom position different from the first screw conveyor bottom position.

Here it is provided that the screw conveyor bottom 35 arranged in the first screw conveyor bottom position corresponds to the sampling inlet with the first inlet opening size, and the screw conveyor bottom 35 arranged in the second screw conveyor bottom position corresponds to the sampling inlet with the second inlet opening size.

A particle measuring device 40 is provided in the bypass conduit channel 23 downstream of the bypass conduit inlet opening 21. The particle measuring device 40 is designed for the continuous measurement of particle sizes of the measurement sample 3 taken in the main conduit and the measurement sample provided in the bypass conduit 20. For this purpose, the particle measuring device 40 has a measurement sample inlet 41, through which the measurement sample 3 can be continuously fed to the particle measuring device 40. Furthermore, the particle measuring device 40 has a measurement sample outlet 42 on the downstream side, which is fluidically connected to the measurement sample inlet 41. Via the measurement sample outlet 42, the measurement sample 3 detected by the particle measuring device 40 can leave the particle measuring device 40 in the direction of the bypass conduit outlet opening 22.

In the present case, the bypass conduit outlet opening 22 of the bypass conduit 20 is fluidically connected to the main conduit 10. For this purpose, the main conduit 10 has a bypass conduit inlet opening 15 downstream of the bypass conduit outlet opening 14, to which the bypass conduit outlet opening 22 of the bypass conduit 20 is coupled. Thus, in this preferred embodiment, the bypass conduit 20 is fluidically connected to the main conduit 10 both on the inlet side, via the bypass conduit inlet opening 21, and on the outlet side, via the bypass conduit outlet opening 22. This means that the measurement sample 3 taken from the main conduit 10, which is fed to the bypass conduit 20 on the inlet side, is fed back to the main conduit 10 on the outlet side via the bypass conduit outlet opening 22 and the bypass conduit inlet opening 15 of the main conduit 10.

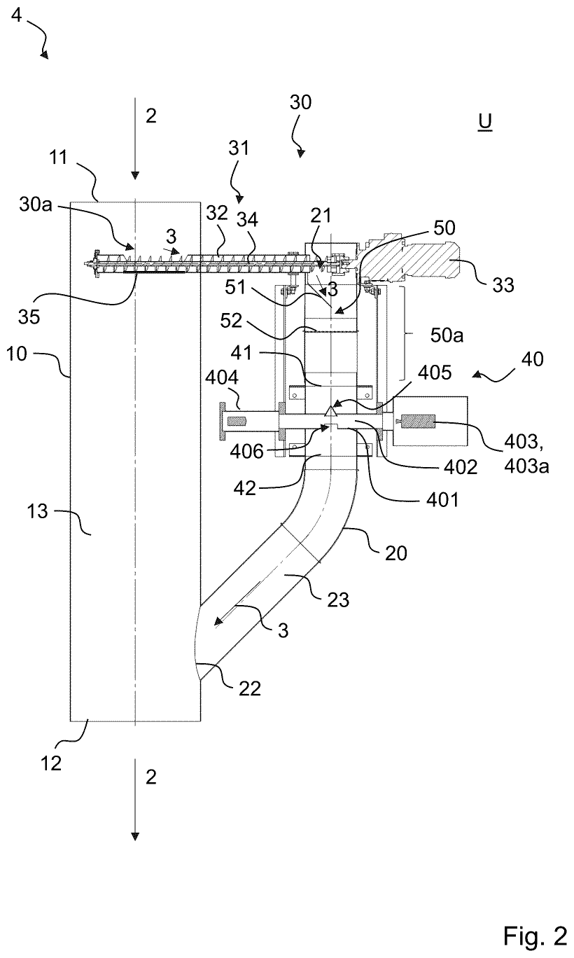

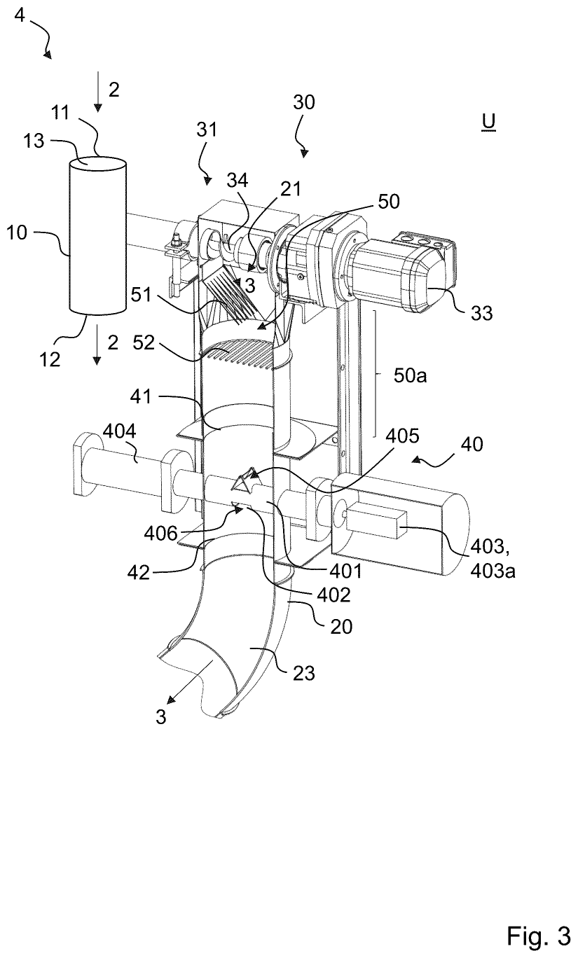

To prepare the measurement sample taken from the main conduit 10, the bypass conduit 20 has a sample preparation path 50a. The sample preparation path 50a extends within the bypass conduit channel 23 downstream of the bypass conduit inlet opening 21 and upstream of the measurement sample inlet 41. The sample preparation path 50a thus extends between the bypass conduit inlet opening 21 and the measurement sample inlet 41. The sample preparation path 50a serves to prepare the measurement sample taken and fed to the bypass conduit 20 for measurement and analysis with the particle measuring device 40. For this purpose, the sample preparation path 50a has a measurement sample preparation unit 50, which evenly distributes particles of the measurement sample in the bypass conduit 20 and dissolves possible clumping of the measurement sample. This function is achieved by a measurement sample distribution plate 51, which distributes the measurement sample 3 supplied via the bypass conduit inlet opening 21 in the sample preparation path 50a, and a measurement sample distribution grid 52, which distributes the measurement sample 3 supplied via the bypass conduit inlet opening 21 in the sample preparation path 50a. FIGS. 2 and 3 show the arrangement of the measurement sample distribution plate 51 and the measurement sample distribution grid 52.

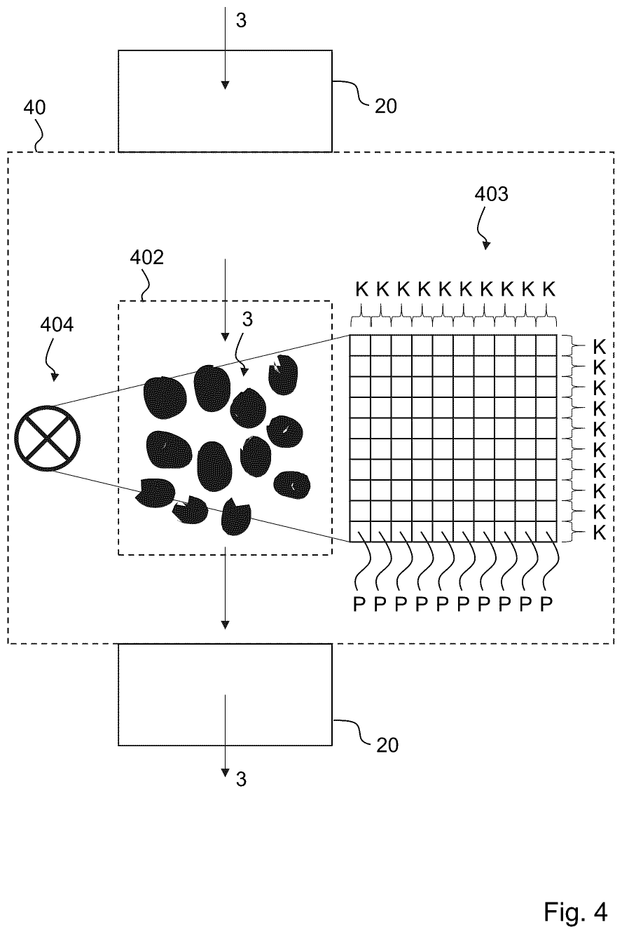

FIGS. 2 to 4 show the specific design of the particle measuring device 40. Thus, FIG. 2 shows a schematic side view in sectional view of the inline particle size analyzing device 4 according to a preferred embodiment of the mill shown in FIG. 1. FIG. 3 shows a schematic three-dimensional sectional view of a section of the embodiment shown in FIG. 2; and FIG. 4 is a schematic representation of a preferred embodiment of a particle measuring device 40 of the inline particle size analyzing device 4 shown in FIGS. 2 and 3.

The particle measuring device 40 shown in these Figures has a measuring chamber housing 401 which encloses a measuring chamber so that it is darkened with respect to the environment U of the inline particle size analyzing device 4. Furthermore, in this preferred embodiment of the particle measuring device 40, a radiation detector 403 and a radiation source 404 are provided. The radiation detector 403 and the radiation source 404 are arranged opposite to each other, so that the bypass conduit channel or the measuring chamber are arranged between the radiation detector and the radiation source.

The radiation detector 403 is designed to detect electromagnetic radiation. In the present case, the radiation detector 403 is comprised of an infrared camera 403a. The infrared camera 403a can capture up to 6,000 images per second. In the present case, the radiation source 404 is an LED which emits corresponding electromagnetic radiation as an infrared source. The radiation detector 403 and the radiation source 404 are arranged in relation to the measuring chamber in such a way that continuous measurement of the measurement sample 3 is possible, which is continuously fed to the measuring chamber through a measuring chamber inlet 405 and is continuously led away from the measuring chamber through a measuring chamber outlet 406. Radiation detector 403 and radiation source 404 are preferably arranged in such a way that the measurement axis extends orthogonally to the flow direction of the measurement sample in the bypass conduit.

The radiation detector is matrix-shaped and has detector pixels P arranged in a matrix. This is shown schematically in FIG. 4. The detector pixels P have an edge length K of preferably 85 μm*85 μm. With this radiation detector, particle sizes of at least 50 μm and a maximum of 6,000 μm can be detected.

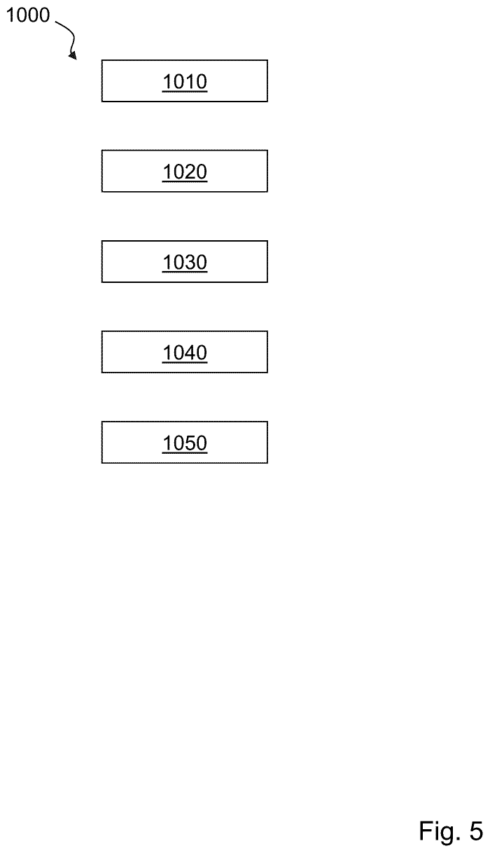

FIG. 5 shows a schematic block diagram of a preferred embodiment of a method 1000 for controlling a hammer mill for grinding bulk material 3 to be ground in dependence on measurement results of an inline particle size analyzing device 40. The method comprises the following steps:

The control method 1000 requires the detection 1010 of an ACTUAL grain spectrum of a measurement sample by means of a particle measuring device and its analysis 1020. Furthermore, it is necessary for the control method 1000 to define a TARGET grain spectrum 1030. For example, a lower limit and an upper limit can be defined as the TARGET grain spectrum.

The method 1000 then comprises a comparison 1040 of the detected ACTUAL grain spectrum with the defined TARGET grain spectrum.

Depending on the result of the comparison of the detected ACTUAL grain spectrum with the defined TARGET grain spectrum, one or more of the following mill parameters can then be set:
Speed of a rotor of the mill, which drives several hammer mill beaters of the mill;
Amount of an air volume flow that flows through the mill, and
Feed quantity of the bulk material to be ground.

1.-21. (canceled)

22. An inline particle size analyzing device for continuous measurement of particle sizes of a continuously collected measurement sample of a free-flowing bulk material ground by a mill, the inline particle size analyzing device comprising:
a main conduit having a main conduit inlet opening and a main conduit outlet opening which are fluidically connected for transporting the bulk material via a main conduit channel from the main conduit inlet opening to the main conduit outlet opening;
a bypass conduit having a bypass conduit inlet opening and a bypass conduit outlet opening that are fluidically connected for continuously transporting the continuously collected measurement sample of the bulk material via a bypass conduit channel from the bypass conduit inlet opening and to the bypass conduit outlet opening, wherein the bypass conduit is fluidically connected to the main conduit channel via the bypass conduit inlet opening for conveying the measurement sample taken from the bulk material to the bypass conduit;
a measurement sampling unit adapted to continuously collect the continuously collected measurement sample of the bulk material transported in the main conduit channel and to continuously supply the continuously collected measurement sample to the bypass conduit channel via the bypass conduit inlet opening; and
a particle measuring device provided in the bypass conduit channel adapted for the continuous measurement of particle sizes of the continuously collected measurement sample, and including a measurement sample inlet, through which the continuously collected measurement sample can be continuously fed to the particle measuring device, and including a measurement sample outlet arranged downstream of the particle measuring device and fluidically connected to the particle measuring device, through which the continuously collected measurement sample detected by the particle measuring device in the bypass conduit channel can leave the particle measuring device in the direction of the bypass conduit outlet opening;
wherein the measurement sampling unit has an adjustable sampling inlet, the inlet opening size of which is adjustable between a first inlet opening size and a second inlet opening size different from the first inlet opening size, the second inlet opening size being larger than the first inlet opening size.

23. The inline particle size analyzing device according to claim 22, wherein the particle measuring device further comprises:
a measuring chamber formed within a measuring chamber housing, which is darkened with respect to the surroundings of the inline particle size analyzing device;
a radiation detector adapted to detect electromagnetic radiation; and
a radiation source for electromagnetic radiation;
wherein the radiation detector and the radiation source are arranged in relation to the measuring chamber for continuous measurement of the continuously collected measurement sample.

24. The inline particle size analyzing device according to claim 23, wherein:
the radiation detector is or comprises an optical matrix sensor with an evaluation unit;
the radiation detector comprises a visible spectrum camera or infrared camera and the radiation source comprises an infrared source and/or an LED;
the radiation source is a light source adapted to emit a uniform light; and/or
the radiation detector and the radiation source are arranged opposite each other.

25. The inline particle size analyzing device according to claim 23, wherein the radiation detector comprises a camera and the camera captures between at least 24 images per second and a maximum of up to 25,000 images per second.

26. The inline particle size analyzing device according to claim 22, wherein the particle measuring device is configured for measuring particle sizes between of at least 50 μm and a maximum of 20,000 μm.

27. The inline particle size analyzing device according to claim 23, wherein the radiation detector comprises detector pixels arranged in a matrix-like manner, wherein the detector pixels have edge lengths of between at least 50 μm and a maximum of 20,000 μm.

28. The inline particle size analyzing device according to claim 22, wherein the measurement sampling unit comprises a conveying device extending from the main conduit channel and to the bypass conduit channel for continuously conveying the continuously collected measurement sample to the bypass conduit channel.

29. The inline particle size analyzing device according to claim 28, wherein the conveying device comprises a conveyor channel extending between the inlet opening of the measurement sampling unit and a discharge opening, and wherein the conveying device further comprises:
a screw conveyor arranged in the conveyor channel so as to be rotatably driven by a conveyor drive unit, wherein:
the screw conveyor is made of plastic or comprises plastic, and/or
the conveyor channel is made of steel;
an adjustable screw conveyor bottom for receiving the continuously collected measurement sample and supplying the measurement sample to the continuously collected measurement sampling unit, which is adjustable between a first screw conveyor bottom position and a second screw conveyor bottom position different from the first screw conveyor bottom position, so that the sampling inlet corresponds to the first inlet opening size when the screw conveyor bottom is arranged in the first screw conveyor bottom position and corresponds to the second inlet opening size when the screw conveyor bottom is arranged in the second screw conveyor bottom position; and/or
the discharge opening is shaped as a slot, wherein the slot-shaped discharge opening is adapted to distribute the continuously collected measurement sample evenly over an opening cross section of the bypass conduit channel.

30. The inline particle size analyzing device according to claim 22, comprising a sample preparation path extending between the bypass conduit inlet opening and the measurement sample inlet of the particle measuring device, wherein the sample preparation path comprises a measurement sample preparation unit and/or an air purification unit.

31. The inline particle size analyzing device according to claim 30, wherein the measurement sample preparation unit comprises:
a measurement sample distributor plate that distributes the continuously collected measurement sample supplied via the bypass conduit inlet opening in the sample preparation path, the measurement sample distributor plate being arranged exchangeably and/or detachably on the bypass conduit;
a measurement sample distributor grid that distributes the continuously collected measurement sample supplied via the bypass conduit inlet opening in the sample preparation path, wherein the measurement sample distributor grid has a plurality of distributor rods arranged equidistantly from one another, and wherein:
the distributor rods are configured as round steel,
the distribution rods have a diameter of at least 5 mm,
the distribution rods have a length between at least 100 mm and a maximum of 250 mm,
the distribution rods are connected to or with a wall of the bypass conduit; and/or
a nozzle unit, wherein the nozzle unit is arranged on the bypass conduit upstream of the measurement sample distributor grid and/or the measurement sample distributor plate.

32. The inline particle size analyzing device according to claim 22, wherein the particle measuring device comprises a measuring chamber inlet through which the continuously collected measurement sample can be continuously supplied to the measuring chamber, and a measuring chamber outlet through which the continuously collected measurement sample can continuously leave the measuring chamber.

33. The inline particle size analyzing device according to claim 22, wherein the particle measuring device is adapted to perform a measurement of the continuously collected supplied measurement sample when the amount of the continuously collected measurement sample exceeds a limit amount.

34. The inline particle size analyzing device according to claim 23, further comprising a dirt detection unit for detecting dirt in the radiation detector and/or the radiation source of the particle measuring device and/or wherein the radiation detector forms or is the dirt detection unit.

35. The inline particle size analyzing device according to claim 23, further comprising a cleaning device for cleaning the radiation detector and/or the radiation source of the particle measuring device from contamination.

36. The inline particle size analyzing device according to claim 35, wherein the cleaning device comprises or is a blower for cleaning the radiation detector and/or the radiation source of the particle measuring device.

37. A mill for grinding bulk material to be ground, the mill comprising:
a grinding chamber enclosed by a grinding chamber housing with a grinding device for grinding bulk material to be ground, which grinding device is arranged within the grinding chamber so as to be rotatably drivable by a grinding drive unit;
a bulk material inlet for feeding bulk material to be ground into the grinding chamber and a bulk material outlet for discharging bulk material ground by the grinding device from the grinding chamber; and
an inline particle size analyzing device for continuous measurement of particle sizes of a continuously collected measurement sample of a free-flowing bulk material ground by a mill, the inline particle size analyzing device comprising:
a main conduit having a main conduit inlet opening and a main conduit outlet opening which are fluidically connected for transporting the bulk material via a main conduit channel from the main conduit inlet opening to the main conduit outlet opening;
a bypass conduit having a bypass conduit inlet opening and a bypass conduit outlet opening that are fluidically connected for continuously transporting the continuously collected measurement sample of the bulk material via a bypass conduit channel from the bypass conduit inlet opening and to the bypass conduit outlet opening, wherein the bypass conduit is fluidically connected to the main conduit channel via the bypass conduit inlet opening for conveying the measurement sample taken from the bulk material to the bypass conduit;
a measurement sampling unit adapted to continuously collect the continuously collected measurement sample of the bulk material transported in the main conduit channel and to continuously supply the continuously collected measurement sample to the bypass conduit channel via the bypass conduit inlet opening; and
a particle measuring device provided in the bypass conduit channel adapted for the continuous measurement of particle sizes of the continuously collected measurement sample, and including a measurement sample inlet, through which the continuously collected measurement sample can be continuously fed to the particle measuring device, and including a measurement sample outlet arranged downstream of the particle measuring device and fluidically connected to the particle measuring device, through which the continuously collected measurement sample detected by the particle measuring device in the bypass conduit channel can leave the particle measuring device in the direction of the bypass conduit outlet opening;
wherein the measurement sampling unit has an adjustable sampling inlet, the inlet opening size of which is adjustable between a first inlet opening size and a second inlet opening size different from the first inlet opening size, the second inlet opening size being larger than the first inlet opening size; and
wherein the inline particle size analyzing device is arranged downstream of the bulk material outlet for continuously measuring particle sizes of the continuously collected measurement sample of the bulk material ground by the grinding device, and wherein the main conduit is fluidically coupled to the bulk material outlet via the main conduit inlet opening.

38. The mill according to claim 37, further comprising a sieving unit arranged at the bulk material outlet for sieving the ground bulk material.

39. The mill according to claim 37, further comprising a control device which is signally connected to the particle measuring device and the grinding drive unit, and wherein the control device is adapted to control the grinding drive unit in dependence on measurement results of the continuous measurement by the particle measuring device.

40. A method for controlling a mill for grinding bulk material to be ground in dependence on measurement results of an inline particle size analyzing device for continuous measurement of particle sizes of a continuously collected measurement sample of a free-flowing bulk material ground by a mill, the inline particle size analyzing device comprising:
a main conduit having a main conduit inlet opening and a main conduit outlet opening which are fluidically connected for transporting the bulk material via a main conduit channel from the main conduit inlet opening to the main conduit outlet opening;
a bypass conduit having a bypass conduit inlet opening and a bypass conduit outlet opening that are fluidically connected for continuously transporting the continuously collected measurement sample of the bulk material via a bypass conduit channel from the bypass conduit inlet opening and to the bypass conduit outlet opening, wherein the bypass conduit is fluidically connected to the main conduit channel via the bypass conduit inlet opening for conveying the measurement sample taken from the bulk material to the bypass conduit;
a measurement sampling unit adapted to continuously collect the continuously collected measurement sample of the bulk material transported in the main conduit channel and to continuously supply the continuously collected measurement sample to the bypass conduit channel via the bypass conduit inlet opening; and
a particle measuring device provided in the bypass conduit channel adapted for the continuous measurement of particle sizes of the continuously collected measurement sample, and including a measurement sample inlet, through which the continuously collected measurement sample can be continuously fed to the particle measuring device, and including a measurement sample outlet arranged downstream of the particle measuring device and fluidically connected to the particle measuring device, through which the continuously collected measurement sample detected by the particle measuring device in the bypass conduit channel can leave the particle measuring device in the direction of the bypass conduit outlet opening;
wherein the measurement sampling unit has an adjustable sampling inlet, the inlet opening size of which is adjustable between a first inlet opening size and a second inlet opening size different from the first inlet opening size, the second inlet opening size being larger than the first inlet opening size;
the method comprising the steps of:
detection of an ACTUAL grain spectrum of a measurement sample by means of a particle measuring device;
analysis of the detected ACTUAL grain spectrum;
define a TARGET grain spectrum;
comparison of the detected ACTUAL grain spectrum with the defined TARGET grain spectrum; and
setting of one or more of the following mill parameters in dependence on the result of the comparison of the detected ACTUAL grain spectrum with the defined TARGET grain spectrum:
speed of a rotor of the mill,
amount of an air volume flow that flows through the mill, and/or
feed quantity of the bulk material to be ground.

41. A computer program product comprising program code to carry out, when executed by a processor circuit, the method of claim 40.

42. A non-transitory computer readable storage medium comprising instructions which, when executed by a processor circuit, cause the processor circuit to perform the method of claim 40.
